(19) United States
(12) Patent Application Publication
(10) Pub. No.: US 2025/0111073 A1
(43) Pub. Date: Apr. 3, 2025

(54) PROTECTING SENSITIVE DATA IN TEXT-BASED GEN-AI SYSTEM

(71) Applicant: Baffle, Inc., Santa Clara, CA (US)

(72) Inventors: Min-Hank Ho, Santa Clara, CA (US); Palanivel Rajan Shanmugavelayutham, Santa Clara, CA (US); Kishore Kumar Chandrasekaran, Santa Clara, CA (US); Balaji Govindan, Santa Clara, CA (US); Priyadarshan Kolte, Santa Clara, CA (US)

(21) Appl. No.: 18/951,158

(22) Filed: Nov. 18, 2024

Related U.S. Application Data
(60) Provisional application No. 63/540,938, filed on Sep. 28, 2023.
(60) Provisional application No. 63/627,637, filed on Jan. 31, 2024.

(51) Int. Cl. G06F 21/62; G06F 21/60

(52) U.S. Cl. CPC G06F 21/6218; G06F 21/602

(57) ABSTRACT

The present embodiments relate to systems and methods to selectively encrypt data for a generative artificial intelligence (GenAI) application. The systems and methods as described herein provide access control for generative AI applications by applying encryption at the data level for all sensitive and regulated data values. Each data value identified as containing sensitive data can be individually encrypted with associated metadata that supports downstream processing by generative AI components and for access control. The encryption can be performed by inline network proxies that are configured by a centralized configuration management service. The use of centralized configuration management can be used for encryption and associated access control policies that is consistent across all of the data paths into and out of the protected systems.

### CROSS-REFERENCE TO RELATED APPLICATION(S)

The present application claims the benefit of U.S. Provisional Patent Application No. 63/540,938, filed Sep. 28, 2023, and titled “PROTECTING SENSITIVE DATA IN TEXT-BASED GEN-AI SYSTEM,” and U.S. Provisional Patent Application No. 63/627,637, filed Jan. 31, 2024, and titled “PROTECTING SENSITIVE DATA IN TEXT-BASED GEN-AI SYSTEM,” the entirety of which is incorporated by reference herein.

### FIELD

This invention is relevant in the field of generative artificial intelligence (GenAI). The disclosed techniques may be applied to, for example, maintaining data privacy and regulatory compliance while leveraging generative AI capabilities in various industries and applications.

### BACKGROUND

Generative AI systems, powered by large language models (LLMs), have emerged as powerful tools capable of processing and generating human-like responses to natural language prompts. These systems can extract valuable insights from vast pools of seemingly unrelated data, offering unprecedented capabilities in information retrieval and analysis. However, the ability to sift through large datasets to find specific information of interest also presents significant challenges in protecting sensitive, private, or regulated data.

Organizations across various industries are increasingly interested in leveraging generative AI technologies to enhance their operations and decision-making processes. However, they often face a dilemma when considering the use of datasets that may contain regulated or sensitive information. Data privacy regulations and contractual obligations typically require controlled access to such data on a “need-to-know” basis.

Existing approaches to address data security concerns in generative AI systems have focused on filtering techniques, such as pattern matching using regular expressions or employing additional AI systems trained to identify sensitive information based on context. More advanced methods utilize machine learning techniques like Reinforcement Learning from Human Feedback (RLHF) to optimize systems for blocking responses containing sensitive information.

However, these solutions often struggle with accuracy, producing both false positives and false negatives. This can result in the inadvertent disclosure of sensitive information or the unintended blocking of non-sensitive data. Furthermore, the effectiveness of these filtering systems can be compromised by users actively attempting to circumvent them. Simple adjustments to the phrasing of questions can often bypass security measures, exposing weaknesses in current generative AI services. The challenge lies in reliably determining the sensitivity of data solely from the prompt or the response of the generative AI system, as the security context is often lost when data is combined with other information in the AI's training set.

The development of robust, customizable, and deterministic solutions for provably protecting specific sensitive data and providing differentiated levels of access based on authorization remains a significant challenge in the field of generative AI. There is a growing need for innovative approaches that can maintain data privacy and regulatory compliance while still harnessing the powerful capabilities of generative AI systems across various industries and applications.

### SUMMARY

The present embodiments relate to systems and methods to selectively encrypt data for a generative artificial intelligence (GenAI) application. The systems and methods as described herein provide access control for generative AI applications by applying encryption at the data level for all sensitive and regulated data values. Each data value identified as containing sensitive data can be individually encrypted with associated metadata that supports downstream processing by generative AI components and for access control.

The encryption can be performed by inline network proxies that can use the application-level network protocols in the data ingestion phase of the data pipeline. The inline proxies are configured by a centralized configuration management service. The use of centralized configuration management can be used for encryption and associated access control policies that is consistent across all of the data paths into and out of the protected systems. The present systems can avoid the loss of access control enforcement when the data moves between systems.

In a first example embodiment, a method performed to selectively encrypt data for a generative artificial intelligence (GenAI) application is provided. The method can include implementing, by a management compute node, a first proxy compute node in electrical communication with one or more input data sources configured to provide a set of input data and a large language model (LLM) or a retrieval-augmented generation (RAG) system. The management compute node can transmit a set of access control policies to the first proxy agent compute node.

The method can also include identifying, at the first proxy agent compute node, a set of data values in the input data that include sensitive information as defined in the set of access control policies. The method can also include, for each data value in the identified set of data values, encrypting the data value and storing the encrypted data value with metadata at a database.

The method can also include forwarding a remaining portion of the input data to the LLM or the RAG system as training data to train the LLM or the RAG system. The method can also include implementing a second proxy agent compute node in electrical communication with a user device and a GenAI application in communication with the LLM or the RAG system.

The method can also include obtaining, at the second proxy agent compute node, a prompt from the user device and identifying an access level for the user device according to the set of access control policies. The method can also include obtaining, at the second proxy agent compute node, a response to the prompt from the GenAI application. The method can also include decrypting all or a portion of the encrypted data values in the response to the prompt based on the access level for the user device. The method can also include transmitting, by the second proxy agent compute node, the response to the prompt to the user device.

In some instances, any of the first proxy agent compute node and the second proxy agent compute node connects to a database that is part of the input data sources via a database native communication protocol, the first proxy agent compute node and the second proxy agent compute node connects to a file transfer server that is part of the input data sources via a secure file transfer protocol (SFTP), and wherein the first proxy agent compute node and the second proxy agent compute node connects to a cloud-based server that is part of the input data sources via hypertext transfer protocol secure (HTTPS).

In some instances, the set of access control policies include defined classification labels for each type of data values that are to be encrypted.

In some instances, each of the identified set of data values in the input data that include sensitive information include any of: a universally unique identifier (UUID) for each data value, an encryption key for encrypting the data value, a pre-encryption data type for the data value, a defined classification label for the data value, a LLM type, and a vector representation of the data value.

In some instances, the metadata for each data value is arranged in a tag-length-value format that arranges multiple metadata elements of varying lengths.

In some instances, the input data received at the first proxy agent compute node comprises a full text corpus, and the first proxy agent compute node can generate a position vector for each data value in the identified set of data values. The position vector can include a mathematical representation of the data value.

In some instances, the first proxy agent compute node stores the position vector for each data value in the database that comprises a vector database.

In some instances, the UUID and defined classification label for the data value create an address for each data value for the set of access control policies.

In some instances, the encrypted data value and the metadata are encrypted using a keyed cryptographic hash.

In some instances, the method further includes detecting, by a detection engine in communication with the second proxy agent compute node, a first data value mis-identified by the first proxy agent compute node and encrypting or masking the first data value according to the set of access control policies.

In another example embodiment, a management compute node is provided. The management compute node can include one or more processors and a memory. The memory can include instructions that, when executed, cause the one or more processors to perform a series of steps. The processors can be configured to a first proxy compute node in electrical communication with one or more input data sources configured to provide a set of input data and a large language model (LLM) or a retrieval-augmented generation (RAG) system.

The processors can be further configured to transmit a set of access control policies to the first proxy agent compute node. The first proxy agent compute node is configured to identify a set of data values in the input data that include sensitive information as defined in the set of access control policies. The first proxy agent compute node can be configured to, for each data value in the identified set of data values, encrypt the data value and store the encrypted data value with metadata at a database. The processors can be further configured to forward a remaining portion of the input data to the LLM or the RAG system as training data to train the LLM or the RAG system.

The processors can be further configured to implement a second proxy agent compute node in electrical communication with a user device and a GenAI application in communication with the LLM or the RAG system. The processors can be further configured to transmit the set of access control policies to the second proxy agent compute node.

The second proxy agent compute node is configured to obtain a prompt from the user device, identify an access level for the user device according to the set of access control policies, and obtain a response to the prompt from the GenAI application. The second proxy agent compute node can be configured to decrypt all or a portion of the encrypted data values in the response to the prompt based on the access level for the user device and transmit the response to the prompt to the user device.

In some instances, any of the first proxy agent compute node and the second proxy agent compute node connects to a database that is part of the input data sources via a database native communication protocol, the first proxy agent compute node and the second proxy agent compute node connects to a file transfer server that is part of the input data sources via a secure file transfer protocol (SFTP), and wherein the first proxy agent compute node and the second proxy agent compute node connects to a cloud-based server that is part of the input data sources via hypertext transfer protocol secure (HTTPS).

In some instances, each of the identified set of data values in the input data that include sensitive information include any of: a universally unique identifier (UUID) for each data value, an encryption key for encrypting the data value, a pre-encryption data type for the data value, a defined classification label for the data value, a LLM type, and a vector representation of the data value.

In some instances, the input data received at the first proxy agent compute node comprises a full text corpus, and wherein the first proxy agent compute node generates a position vector for each data value in the identified set of data values, wherein the position vector comprises a mathematical representation of the data value, wherein the first proxy agent compute node stores the position vector for each data value in the database that comprises a vector database.

In some instances, the instructions further cause the one or more processors to: detect a first data value mis-identified by the first proxy agent compute node and encrypt or mask the first data value according to the set of access control policies.

In another example embodiment, a computer-implemented method is provided. The computer-implemented method can include implement a first proxy compute node in electrical communication with one or more input data sources configured to provide a set of input data and a model for a generative artificial intelligence (GenAI) application. The computer-implemented method can also include transmitting a set of access control policies to the first proxy agent compute node. The first proxy agent compute node can be configured to identify a set of data values in the input data that include sensitive information as defined in the set of access control policies. The first proxy agent compute node can be configured to, for each data value in the identified set of data values, encrypt the data value and store the encrypted data value with metadata at a database.

The computer-implemented method can also include implement a second proxy agent compute node in electrical communication with a user device and the GenAI application in communication with the model. The computer-implemented method can also include transmit the set of access control policies to the second proxy agent compute node. The second proxy agent compute node can be configured to obtain a prompt from the user device, identify an access level for the user device according to the set of access control policies, and obtain a response to the prompt from the GenAI application. The second proxy agent compute node can be configured to decrypt all or a portion of the encrypted data values in the response to the prompt based on the access level for the user device and transmit the response to the prompt to the user device.

In some instances, any of the first proxy agent compute node and the second proxy agent compute node connects to a database that is part of the input data sources via a database native communication protocol, the first proxy agent compute node and the second proxy agent compute node connects to a file transfer server that is part of the input data sources via a secure file transfer protocol (SFTP), and wherein the first proxy agent compute node and the second proxy agent compute node connects to a cloud-based server that is part of the input data sources via hypertext transfer protocol secure (HTTPS).

In some instances, each of the identified set of data values in the input data that include sensitive information include any of: a universally unique identifier (UUID) for each data value, an encryption key for encrypting the data value, a pre-encryption data type for the data value, a defined classification label for the data value, a LLM type, and a vector representation of the data value.

In some instances, the input data received at the first proxy agent compute node comprises a full text corpus, and wherein the first proxy agent compute node generates a position vector for each data value in the identified set of data values, wherein the position vector comprises a mathematical representation of the data value, wherein the first proxy agent compute node stores the position vector for each data value in the database that comprises a vector database.

In some instances, computer-implemented method further comprises determining whether the set of access control policies are within a set of compliance parameters and adding the set of access control policies and the determination of whether the set of access control policies are within the set of compliance parameters to a compliance report.

### BRIEF DESCRIPTION OF THE DRAWINGS

FIG. 1 depicts an exemplary pipeline 100 for protecting sensitive data in a generative AI application in accordance with an embodiment.

FIG. 2 is an example pipeline for custom trained or fine-tuned LLM used for text-based generative AI applications according to some embodiments.

FIG. 3 illustrates an example pipeline for retrieval augmented generation (RAG) for text-based generative AI applications according to some embodiments.

FIG. 4 is an example data protection pipeline for AI used in a LLM training pipeline according to some embodiments.

FIG. 5 is an example data protection pipeline for AI used in a RAG pipeline according to some embodiments.

FIG. 6 illustrates a flow process of an example interaction between ingestion and consumption proxies and AI components according to some embodiments.

FIG. 7 is a diagram illustrating an example system for selectively encrypting data for a generative artificial intelligence (GenAI) application according to some embodiments.

FIG. 8 shows an example computing device which may be used in the systems and methods described herein according to some embodiments.

### DETAILED DESCRIPTION

Reference will now be made in detail to embodiments, examples of which are illustrated in the accompanying drawings. In the following detailed description, numerous specific details are set forth in order to provide a sufficient understanding of the subject matter presented herein. But it will be apparent to one of ordinary skill in the art that the subject matter may be practiced without these specific details. Moreover, the particular embodiments described herein are provided by way of example and should not be used to limit the scope of the invention to these particular embodiments. In other instances, well-known data structures, timing protocols, software operations, procedures, and components have not been described in detail so as not to unnecessarily obscure aspects of the embodiments of the invention.

Generative AI (GenAI) is poised to alter the way many people use information systems due to its ability to model human-like responses to natural language prompts through the use of large language models (LLMs) trained using huge datasets. Through GenAI systems, any user can easily extract valuable insights from a large pool of seeming unrelated and disparate data. Unfortunately, this ability to sift through large data sets to find a specific dataset of interest can be abused to reveal private, sensitive, or regulated data. Data privacy regulations or contractual obligations typically require access to this type of data to be controlled and granted on a “need to know” basis. Thus, companies seeking to use GenAI with datasets that might include some regulated data are confronted with the dilemma of abandoning the effort or running afoul of their legal and contractual obligations. As disclosed herein, a data protection system may solve the problem of enabling a company to retain privacy of their sensitive data while allowing legitimate user-controlled access to the insights obtained from generative AI.

Several approaches have been proposed to address security concerns relating to use of GenAI. Some focus on a filtering approach that identifies sensitive information to block using pattern matching such as regular expressions or another AI system trained to figure out sensitivity of data from the context. More sophisticated approaches use machine learning techniques like Reinforcement Learning from Human Feedback (RLHF) to optimize the system to block responses with sensitive information.

All of the aforementioned solutions can be known to have false positives and false negatives. This means that they may allow sensitive information to be disclosed or accidentally block access to information that need not be controlled. This is due to filters not being able to reliably determine whether or not data is sensitive just from the prompt or the response of the GenAI system. The security context for the data was lost when it got comingled with the pool of other data that is used as the basis for the generative AI system. As a result, these solutions may not prove true assurance that sensitive data is controlled and protected at all times. At the same time, they may also frustrate legitimate users by denying them the ability to use the service for no good reason.

Furthermore, against actual humans that are actively trying to circumvent these filters, the weaknesses of these systems are often quickly exposed and shared with others to reuse. For example, many generative AI services have implemented security filters to prevent users from using them to find dangerous or sensitive content. For example, ways to bypass these filters, by adjusting the way the questions are asked, may be readily available via a simple search.

Finally, many solutions can be developed with great effort to be generally useful and once released for use are not easy to customize for protecting specific sensitive data and for providing different levels of access to sensitive data for specific users.

In some aspects, a system may address the data security and compliance for generative AI systems by encrypting the data at the field level at the beginning of data pipeline using an inline encryption proxy for the data store. Encrypting at this stage means that there may be more context regarding the nature of the data to decide which data values require protection and ensure that it stays protected throughout the flow of the data through all components of the generative AI system.

More specifically, the decision to encrypt may be defined in a declarative policy at an early stage. For example, a company may define a policy that all social security numbers must be encrypted. The policy may include information about where the social security number is stored in the data store (e.g. table column, JSON field, etc.) as well as how to protect it (e.g. encryption, tokenization, or masking).

When the data is encrypted, an encoded version of the metadata may be stored with the encrypted value to identify, among other information, the keys used to encrypt the data, embedding information, the nature or data (e.g. identifying the data as a social security number), and/or access control policies. In some aspects, the metadata may be used to identify relationships within the data to better contextualize the information to the generative AI system. Effectively, the encrypted data value is simultaneously protected and labeled. The generative AI system is sent encrypted and labeled data for training, fine-tuning, and in prompts for inference.

In some aspects, API-based encryption may be utilized as an alternative to the inline encryption proxy. The encryption APIs may provide various encryption algorithms and key management services, allowing for customization based on specific security requirements. API-based encryption may automatically extract and encode metadata as described herein.

In some aspects, the encryption used in the system may be reversible or non-reversible. Reversible encryption allows the original data to be recovered using a decryption key, which may be useful when authorized users need to access the unencrypted information. Non-reversible encryption, such as one-way hashing, may be employed when the original data does not need to be retrieved. In some cases, metadata can be embedded in synthetic data generated by the system. The metadata may be encoded within the synthetic data in a way that does not compromise the privacy of the original sensitive information. In embodiments featuring synthetic data, metadata based on the original (i.e., non-hashed) may support downstream mathematical or logic operations (e.g. cosine distance) such that the generative AI may produce valid responses.

When the data value is incorporated as part of the response to a given prompt or inference request, the user may access the generative AI application through another proxy that proxies for the web service that would provide the prompt/response interface. The purpose of the proxy may be to decrypt or mask the value for authorized users. The authorization may be determined based on an identity management framework. Example identity management frameworks include OpenID Connect (OIDC) or Security Assertion Markup Language (SAML). The proxy may use customizable policies known as Role Based Access Control (RBAC) to control the level of access for each authorized user or group of users. RBAC policies may be managed centrally to apply to all proxies that are used in the processing of responses to end users

By encrypting the sensitive values, some responses to prompts may differ from those that would be given had the system accessed the cleartext version of the data. However, in most valid or allowed use cases at business, inference responses are not affected by anonymized or encrypted sensitive data values. For example, when asked about controlled information (e.g., someone's personal email address) that was encrypted earlier in the pipeline, the generative AI system may give a natural language response similar to when the controlled information is not encrypted. The difference is that the sensitive information within the natural language response will appears to the user as an encrypted or masked value when the user lacked authorization to see the controlled information.

Some embodiments differ from other solutions for text-based generative AI by identifying sensitive data and enforcing access control at earliest point of data pipelines that feeds generative AI systems rather than applying a filter at the end of the pipeline before the data is sent to the user. Furthermore, by labeling the data at a stage where the nature of the data is better known, the system may perform less guessing as to whether a particular data value is sensitive or regulated. The solution may use two inline proxies, one before data is ingested into the generative AI system, and one before the user prompt is sent to the LLM and after the response is received from the LLM.

The system may apply access control enforcement at a different point in the pipeline, as opposed to traditional systems. In some aspects, the system may use cryptography. Previous approaches may avoid using field-level encryption needed to protect data for generative AI systems due to the complexity of having the user implement encryption within new or existing applications, but the disclosed solution may use two inline proxies eliminate the need to make code modification thus reducing complexity.

As a result, sensitive and regulated data may remain protected even if the generative AI gives a response that previously would have been in the clear. Even with adversarial prompting where users succeed in bypassing filters from regular expression pattern match or rules inserted by RLHF, the adversaries may only receive encrypted versions of the sensitive data values. Legitimate users who are granted sufficient access in the RBAC policies may receive useful responses from the generative AI system.

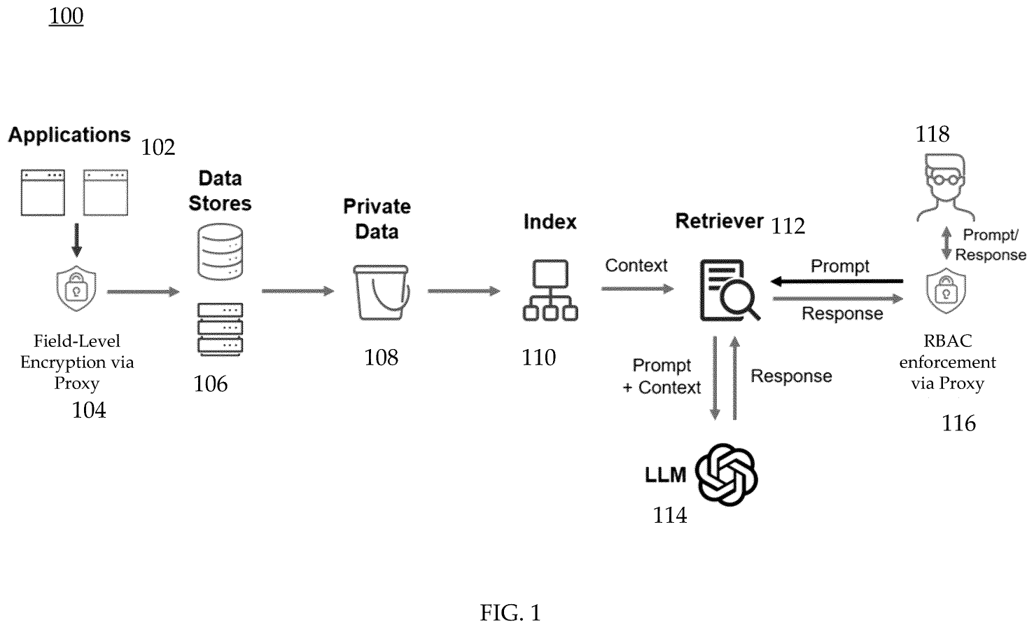

FIG. 1 depicts an exemplary pipeline 100 for protecting sensitive data in a generative AI application in accordance with an embodiment. In some aspects, the pipeline 100 may include applications 102 which provide a dataset to train the generative AI. The applications 102 may interface with a field-level encryption component 104. The field-level encryption 104 may be configured to process data before it is stored in data stores 106. In some cases, the field-level encryption 104 may be a first encryption proxy that encrypts sensitive data fields at a field level in the data stores 106.

In some aspects, the applications 102 may be any type of software or hardware systems that generate, process, or handle data. In some cases, the applications 102 may include, but are not limited to, databases, data processing systems, data analytics systems, or other types of data handling systems. The applications 102 may generate or process data that is to be stored in data stores 106.

In some aspects, the data stores 106 may be any type of data storage systems, such as databases, data warehouses, object stores, data lakes, or other types of data storage systems. The data stores 106 may store various types of data, including private data 108. The private data 108 may include sensitive data fields that have been encrypted and labeled by the field-level encryption 104.

In some aspects, the system 100 may analyze the data stores 106 to identify potential sensitive information. The system 100 may employ natural language processing (NLP) algorithms to scan text and recognize patterns that could indicate sensitive data, such as social security numbers, credit card information, or personal health details. Machine learning models may be trained on large datasets of known sensitive information to recognize similar patterns in new data.

Additionally, or alternatively, the system 100 may utilize contextual analysis to identify potentially sensitive information based on the surrounding text or metadata. For example, an AI system may flag data as potentially sensitive if it appears in proximity to keywords like “confidential” or “private.” In some cases, these systems may also incorporate rule-based approaches, combining predefined patterns and contextual understanding to improve accuracy in identifying sensitive information across diverse datasets.

In some embodiments, the system 100 may include a labeling module, which may be part of the field-level encryption 104 or a separate component. The labeling module may be configured to label the encrypted data fields with metadata in the data stores 106. The metadata may include, but is not limited to, information about the encryption keys used, the nature of the data, and/or access control policies.

The data stores 106 may contain private data 108, which is then indexed in an index 110. The index 110 may be a data structure that improves the speed of data retrieval operations on the data stores 106. The index 110 may contain references to the private data 108 in the data stores 106, thereby allowing the system 100 to quickly locate and access the private data 108.

In some cases, the system 100 may include a retriever 112 that accesses the index 110 to obtain context information. The retriever 112 may be a software or hardware component that retrieves data from the data stores 106 based on the index 110. The retriever 112 may interact with the LLM 114, exchanging prompts, context, and responses. The LLM 114 may generate responses based on the provided prompts and context, which may include the encrypted and labeled data.

The data store 106 and private data 108 may include the encrypted and labeled sensitive data fields. The private data 108 may interface with the generative AI system, which may include a Large Language Model (LLM) 114. The LLM 114 may be trained on the encrypted and labeled data from the data stores 106.

In some aspects, the system 100 may be configured to interface the data stores 106 to the generative AI system. This may involve sending the encrypted and labeled data from the data stores 106 to the LLM 114 for context in prompts for inference. The LLM 114 may generate responses based on the provided prompts and context, which may include the encrypted and labeled data, based on an authorization level of a user associated with the prompt.

In some embodiments, the system 100 may be configured to protect sensitive data in a generative AI application by encrypting sensitive data fields at a field level using a first encryption proxy in a data store, labeling the encrypted data fields with metadata in the data store, and interfacing the data store to the generative AI system.

In some cases, the system 100 may include a Role-Based Access Control (RBAC) enforcement component 116 that manages user 118 interactions. In some aspects, the user 118 may send prompts and receive responses through the RBAC enforcement 116, which ensures appropriate access control. The RBAC enforcement 116 may be a second proxy configured to receive user prompts, send the prompts to the LLM 114, receive responses from the LLM 114, and selectively decrypt sensitive data in the responses based on user authorization.

In some cases, the user 118 may interact with the system 100 by sending a user prompt to the RBAC enforcement 116. The RBAC enforcement 116 may then send the user prompt to the LLM 114. The LLM 114, having been trained on the encrypted and labeled data from the data stores 106, may generate a response based on the provided prompt and context. The generated response may then be sent back to the RBAC enforcement 116.

Upon receiving the response from the LLM 114, the RBAC enforcement 116 may selectively decrypt sensitive data in the response based on user authorization. This selective decryption may involve applying different levels of access to different users based on their roles as defined in the RBAC policies. In some aspects, the RBAC enforcement 116 may also selectively mask sensitive data in the responses based on the user authorization. This may involve replacing the sensitive data with a placeholder or other non-sensitive data for unauthorized users. The selective masking may provide an additional layer of protection for sensitive data, ensuring that unauthorized users cannot access the sensitive data even if they are able to bypass other security measures. In some aspects, the levels of access may be associated with labels applied to the encrypted data in the data stores 106.

In some cases, the user authorization may be determined based on identity management frameworks such as OpenID Connect (OIDC) or Security Assertion Markup Language (SAML). The RBAC enforcement 116 may use these frameworks to determine the level of access for each user or group of users. This may allow the system 100 to provide different levels of access to sensitive data for specific users, thereby ensuring that sensitive data is controlled and protected at all times.

In some aspects, the system 100 may utilize field level encryption 104 configured to encrypt sensitive data fields at a field level in the data stores 106. The encryption 104 may be performed at a first proxy. The encryption may be based on a declarative policy that defines which data values require protection. The declarative policy may specify the location of sensitive data in the data store 106 and a protection method for the sensitive data. For instance, the policy may indicate that all social security numbers stored in a particular location of the data store 106 (e.g., a table column or JSON field) should be encrypted. The protection method may include encryption, tokenization, or masking, among others.

In some cases, the system 100 may include a policy engine, which may be part of the first proxy. The policy engine may be configured to define the declarative policy specifying which data values require protection. This allows the system 100 to identify and protect sensitive data at the earliest point of the data pipeline that feeds the LLM 114.

In some embodiments, the field-level encryption 104 may also label the encrypted data fields with metadata. The metadata may include information about the encryption keys used to encrypt the data, the nature of the data, and/or access control policies. For example, the metadata may indicate that a particular data value is a social security number and should be protected. the labeling process may ensure that the sensitive data is usable by other components of the system 100 when authorized. In some aspects, the metadata may be stored with the encrypted data in the data stores 106. This allows the system 100 to retain the security context for the data, even when it is comingled with other data in the data stores 106.

In some embodiments, the system 100 may include a generative AI model, such as the LLM 114, trained on the encrypted and labeled data from the data stores 106. The LLM 114 may generate responses based on the provided prompts and context, which may include the encrypted and labeled data. In some cases, the LLM 114 may interact with the encrypted data in a way that allows it to generate responses containing encrypted data that can only be decrypted by the RBAC enforcement 116 based on RBAC policies.

In some aspects, the system 100 may be configured to protect sensitive data in a generative AI application by encrypting sensitive data fields at a field level using a first encryption proxy in a data store, labeling the encrypted data fields with metadata in the data store, and interfacing the data store to the generative AI system. As a result, the system 100 may provide controlled access to the insights obtained from the generative AI system while retaining the privacy of the sensitive data.

Various uses of text-based generative AI may rely primarily on the creation and usage of a Large Language Model (LLM). A Foundation LLM is an LLM that has been trained on a very large corpus of training data and which can optionally be further fined-tuned with additional training data. The availability of tools and Foundation LLMs has led to different approaches to developing and deploying generative AI applications. The most common approaches are training of a custom LLM, fine-tuning of an existing foundation LLM, and Retrieval Augmented Generation. These approaches may not be mutually exclusive, and combinations are possible. A common thread among these approaches is that they can require vast amounts of data much of which may contain private and regulated information. Often, this private and regulated data can be poorly controlled, and this lack of control means the current generative AI systems that use private data likely may not comply with most data privacy regulations unless usage of generative AI applications are severely restricted which greatly reduces its applicability.

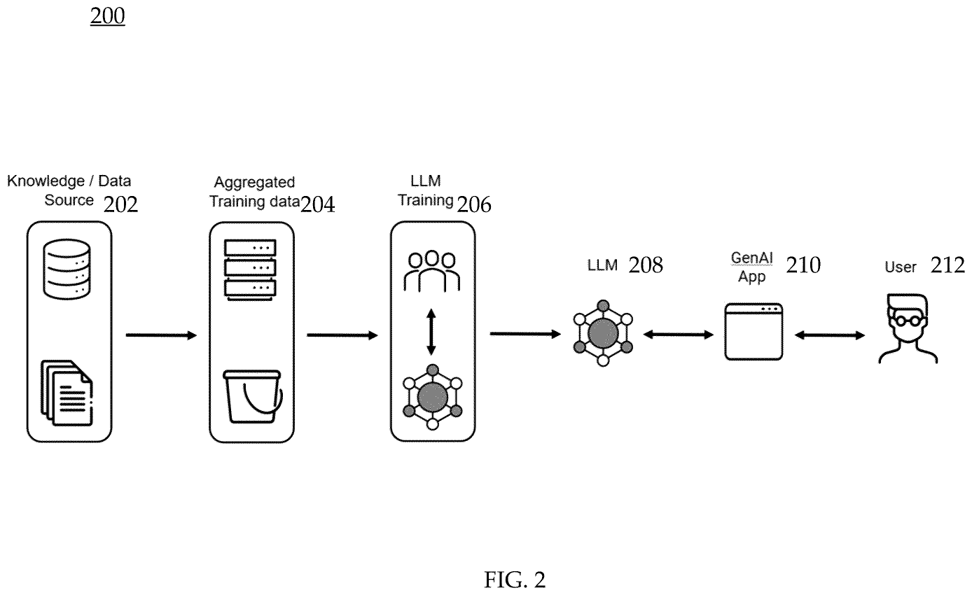

FIG. 2 illustrates an example pipeline 200 for a custom-trained or fine-tuned LLM used for text-based generative AI applications. As shown in FIG. 2, input data can be obtained via a knowledge/data source 202. The knowledge/data source 202 can include any number of data sources, such as remote computing nodes, databases, etc., that can provide input data, such as text to be used in training.

The input data from data source 202 can be aggregated into training data 204. This can include modifying the input data to arrange the data for training. The input data 202 can be filtered to remove certain information, such as non-useful information or sensitive information. The training data 204 can be modified to be prepared for training at the LLM 206. The LLM 208 can perform LLM training 206 using the training data 204 as described herein. A GenAI app 210 can use the trained LLM 208 for performing various GenAI processes as described herein. For instance, the user 212 can submit queries to the GenAI App 210, where the GenAI app 210 uses LLM 208 for generating a response, and the response is fed to the user 212 (via a user device).

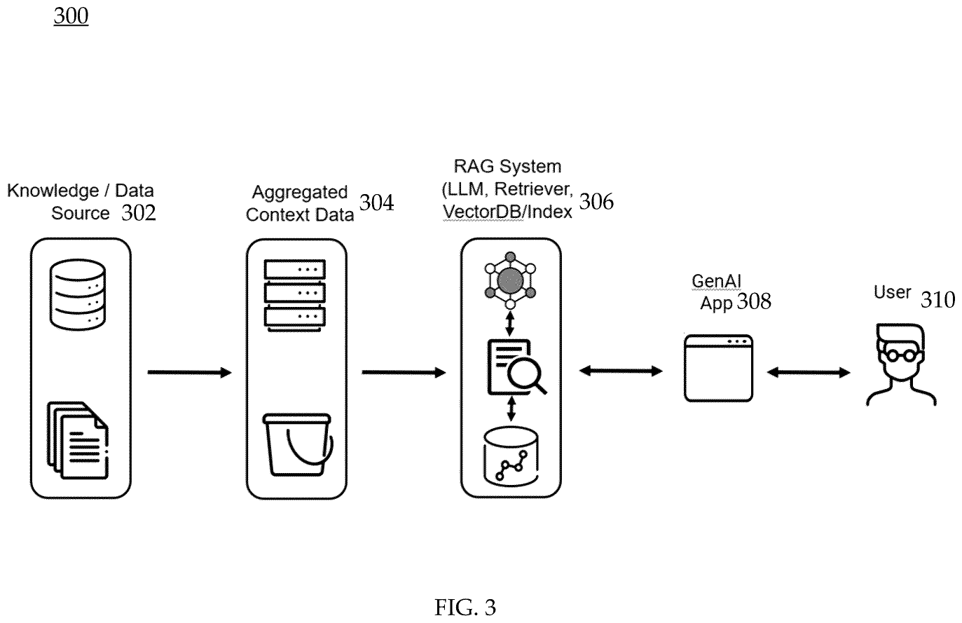

FIG. 3 illustrates an example pipeline 300 for retrieval augmented generation (RAG) for text-based generative AI applications. As shown in FIG. 3, knowledge/source data 302 can provide input data, and the input data can be processed into aggregated context data 304. The aggregated context data 304 can be processed via a RAG system 306. The RAG system 306 can include any of an LLM, a database (VectorDB), and an index. A GenAI app 308 can use the trained RAG 306 for performing various GenAI processes as described herein. For instance, the user 310 can submit queries to the GenAI App 308, where the GenAI app 308 uses RAG 306 for generating a response, and the response is fed to the user 310 (via a user device).

When sensitive or regulated data is provided to generative AI pipelines, the access control policies previously assigned to the data can be lost. This can be due to access control policies requiring an addressable object or location to which the policy is assigned. For example, in a database, an access control policy is typically assigned to a table or column. This can mean that all data residing in any given table or column will be governed by the defined policy assigned to that table or column. Likewise, in a file system, access control may be assigned at a directory or file level meaning that all data in a given directory or file will follow the pre-defined policy.

Many information technology (IT) systems can address the loss of access control policy for data moving from one system to another by recreating the access control policy in the target system that the data moves to. Using the aforementioned examples of databases and files, IT administrators might export a table to a CSV file. To meet compliance requirements, the set of users allowed to access the new CSV file can be configured to match the set of users allowed to access the table. In this regard, there still can be a preservation of access control policies for security compliance.

In the case of a text-based generative AI system, there may not be a way to assign an access control policy to the data it processes. Such systems process text on a token-by-token basis where a token is typically a single word. Furthermore, the data that is ultimately presented to the user of such systems may be an amalgamation of different data values from different data sources. Thus, a generative AI system, in its current form, can create an all-or-nothing access control paradigm where all users granted access to the Gen-AI application effectively can gain access to all of the data values used to create the Gen-AI application (whether the data is incorporated through training of the model or as RAG context). This lack of access controls on regulated data can run afoul of various security compliance requirements leaving organizations with the choice of either running the Gen-AI application and exposing sensitive information to all users or not allowing users to run the Gen-AI application.

Other solutions can generally fall into 3 general categories: 1) Using Data Loss Prevention (DLP) technology to preserve data privacy for generative AI applications, 2) Using Cloud Access Security Broker (CASB) for performing encryption using an inline proxy, 3) Alternate approaches for encrypting individual data values.

The data protection for AI as described herein can address the data security and compliance for generative AI systems by encrypting the data at the field level at the beginning of data pipeline using an inline encryption proxy for the data store. Encrypting at this stage means that there can be more context regarding the nature of the data to decide which data values require protection and ensure that it stays protected through the movement of the data through all components of the generative AI system.

More specifically, the decision to encrypt can be defined in a declarative policy at an early stage. For example, a company can define a policy that all social security numbers must be encrypted. The policy would include information about where the social security number is stored in the data store (e.g., table column, JSON field, etc.) as well as how to protect it (e.g., encryption, tokenization, or masking).

When this data is encrypted, encoded version of the metadata may be stored with the encrypted value to identify, among other information, the keys used to encrypt the data, the nature or data (e.g. the fact it's a social security number), and access control policies. Effectively, the encrypted data value is simultaneously protected and labeled. The GenAI system can send encrypted and labeled data for training, fine-tuning, and in prompts for inference.

When the data value is incorporated as part of the response to a given prompt, the user accesses the GenAI application through another proxy that proxies for the web service that would provide the prompt/response interface. The purpose of this proxy can be to decrypt or mask the value for authorized users. In this case the authorization can be determined based on well-known identity management frameworks such as OpenID Connect (OIDC) or Security Assertion Markup Language (SAML). This proxy uses customizable policies known as Role Based Access Control (RBAC) to control the level of access for each authorized user or group of users.

By encrypting the sensitive values, some responses to prompts may differ from those that would be given had the system accessed the cleartext version of the data. However, in most valid or allowed use cases at business, prompts should not need to process sensitive data values to give an accurate response. For example, when asked about someone's home address that was encrypted earlier in the pipeline, the GenAI system might give some random answer that may not even be an address, but the user should not have been search for home addresses anyway because it is regulated data.

The present embodiments can use data loss prevention (DLP) technology to preserve data privacy for generative AI applications. DLP in this context speaks to the class of solutions for data privacy for generative AI applications that can rely on some sort of filter to prevent access to sensitive data. A filter inspects network traffic between the corporate intranet and the public internet to search for sensitive data values that might be leaving the security boundary. When discovered, it attempts to block the egress of sensitive data. The detection mechanism can be based on regular expressions, user defined rules, scripts, or functions, or AI models.

When applied to generative AI applications, the filter can be applied on user prompts/inputs to the generative AI application or the responses to prevent data leakage. An issue with DLP solutions is the prevalence of false positives and false negatives. Users familiar with the filtering conditions can always craft an alternate prompt or force an alternate response that bypass the filter. This problem can be so well known that public websites, blogs, and even videos share techniques for how to “jailbreak” the popular generative AI chatbots. It also can pose a challenge from a security compliance perspective in that DLP solutions cannot be relied upon as a provable control for data access since its privacy protection capabilities are effectively “best effort.”

The present embodiments can also use a Cloud Access Security Broker (CASB) for performing encryption using an inline proxy. A Cloud Access Security Broker (CASB) product uses an inline HTTP proxy to encrypt data values that are sent by users to Software as a Service (SaaS) cloud services. The goal of encryption can be to ensure that SaaS providers never have access to sensitive or regulated data values from end users while the end users can still see the actual data through the CASB proxy. There can be one or more problems with a CASB solution. First, the CASB can be focused on simple encryption and decryption of values at the HTTP network level, it does not attempt to provide additional access control at the data value level and leaves the access control to the SaaS application. Second, an CASB encryption proxy can be designed for tight constraints on the size and type of the data values transmitted and is not designed for the unrestricted and unstructured data needed for generative AI applications. Finally, a CASB can exclusively proxy a specific network protocol (such as HTTP or HTTPS) and it cannot encrypt sensitive data using a proxy for one network protocol and later decrypt the data value transmitted on another network protocol, so a CASB may not be well suited for generative AI pipelines in which the network protocol used in the data ingestion path is different from the protocol used on the end user consumption path.

The present embodiments can also use other approaches for encrypting individual data values. Many data encryption solutions for encrypting individual data values come in the form of a Software Development Kit (SDK) or a Representational State Transfer Application Programming Interface (REST API). These data encryption solutions can be built for application developers and have 2 problems. First, a SDK or API can generally provide encryption and decryption that acts on a single data value at a time whereas a generative AI system processes a large amount of text containing a large number of sensitive data values in unidentified positions. Second, a SDK or API can integrate with external key management services that enforce key lifecycle policies, but it does not provide integrated access control capabilities and leaves access control to the application logic.

The data protection as described herein can differ from other solutions for text-based GenAI by identifying sensitive data and enforcing access control at earliest point of data pipelines that feeds GenAI systems rather than applying a filter at the end of the pipeline before the data is sent to the user. Furthermore, by labeling the data at a stage where the nature of the data is better known, there is hardly any guessing at whether a particular data value is sensitive or regulated. The present embodiments can use two inline proxies, one just before data is ingested into the GenAI system, and one just before the user prompt is sent to the LLM and after the response is received from the LLM.

The data protection as described herein can apply access control enforcement at a very different point in the pipeline and it can use cryptography. Other approaches may avoid using field-level encryption needed to protect data for GenAI systems due to the complexity, but the present embodiment can use two inline proxies to make data protection easier and more resource-efficient.

The result of the solution is that sensitive and regulated data remain protected even if the GenAI gives a response that previously would have been in the clear. Even with adversarial prompting where users succeed in bypassing filters from regular expression pattern match or rules inserted by RLHF, the adversaries get encrypted versions of the sensitive data values. Legitimate users who are granted sufficient access in the RBAC policies get useful responses from the GenAI system.

The data protection for AI addresses access control for generative AI applications by applying encryption at the data level for all sensitive and regulated data values. This means that each data value that is sensitive, such as a social security or credit card number, can be individually encrypted with associated metadata that supports downstream processing by generative AI components and for access control.

The encryption can performed by inline network proxies that understand the application-level network protocols used in the data ingestion phase of the data pipeline. For databases, this would typically be the native communication protocol of the database. For file servers, this may be SFTP or other common file transfer protocols, for cloud storage services that hold semi-structured and unstructured files, this is usually HTTPS.

These inline proxies can be configured by a centralized configuration management service called a manager. The use of centralized configuration management can be critical to the solution since the ingestion and consumption path may vary greatly depending on the deployment architecture. Thus, the encryption and associated access control policies must be made consistent across all of the data paths into and out of the protected systems. This can avoid the loss of access control enforcement when the data moves between systems.

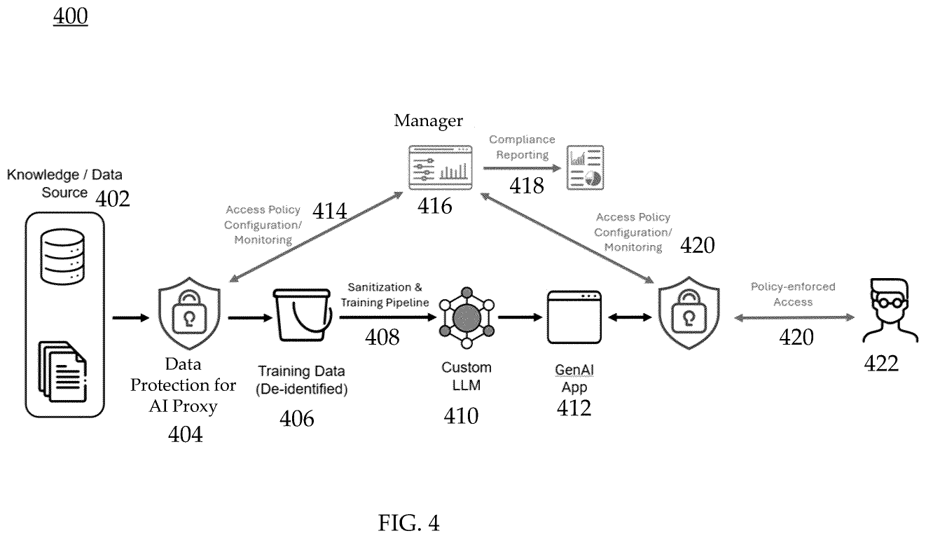

FIG. 4 is an example data protection pipeline 400 for AI used in a LLM training pipeline. As shown in FIG. 4, knowledge/source data 402 can be obtained from any number of data sources (e.g., databases, remote computing nodes). A data protection AI proxy 404 deployed by the manager 416 can process the input data from knowledge/data source 402 to classify the input data or modify the input data to remove sensitive information. For instance, the proxy 404 can process input data and identify all data that incudes personally identifiable information (PII). The proxy 404 can mark any type of data as sensitive or subject to the access policy, as specified by the manager 416.

The proxy 404 can further mark all sensitive data that is only accessible only to users with access. Otherwise, the cleaned data that encrypts or does not show specific information when training the LLM. For instance, the training data 406 generated from the input data is de-identified to remove any sensitive data such that training data does not include any identifiable data. The training data 406 is fed into a sanitization and training pipeline 408 to train the custom LLM 410. The sanitization and training pipeline 408 can include sanitizing the training data 406 and training the LLM 410 by any supervised or unsupervised training techniques.

The manager 416 can manage proxies 404, 420 in the LLM training pipeline and control access policy configuration and monitoring processes. For instance, manager 416 can perform access policy configuration and monitoring processes by a first proxy 404. This can include creating one or more access policies for input data specifying what users have access to different levels of sensitive information. For example, a first access control policy can allow any user access to cleaned data that encrypts any sensitive information. A second control policy can allow a subset of users access to the input data and any PII data in the input data. Another control policy can allow high-credential users access to other sensitive data types, such as medical information, for example.

The manager 416 can also implement a proxy 420 to enable policy-enforced access to the GenAI app 412. For example, a user 422 (via a user device) can have certain accesses to any identified sensitive data in the input data, as controlled by access policies. Based on a query by the user 422, the proxy 420 and manager 416 can identify what, if any, data is to be encrypted or decrypted based on the access control policies for the user 422. For example, if the user 422 has access to insurance claim related PII as specified in a first access control policy, the proxy 420 can make available relevant insurance claim PII data in the queries and prompts to the GenAI app 412.

The manager 416 can perform access policy configuration and monitoring processes 414 and compliance reporting 418 based on monitoring of all access policy configuration and monitoring processes for a GenAI app 412. For example, the compliance reporting 418 can include determining whether access policies accurately are encrypting data and selectively allowing access to data based on compliance requirements.

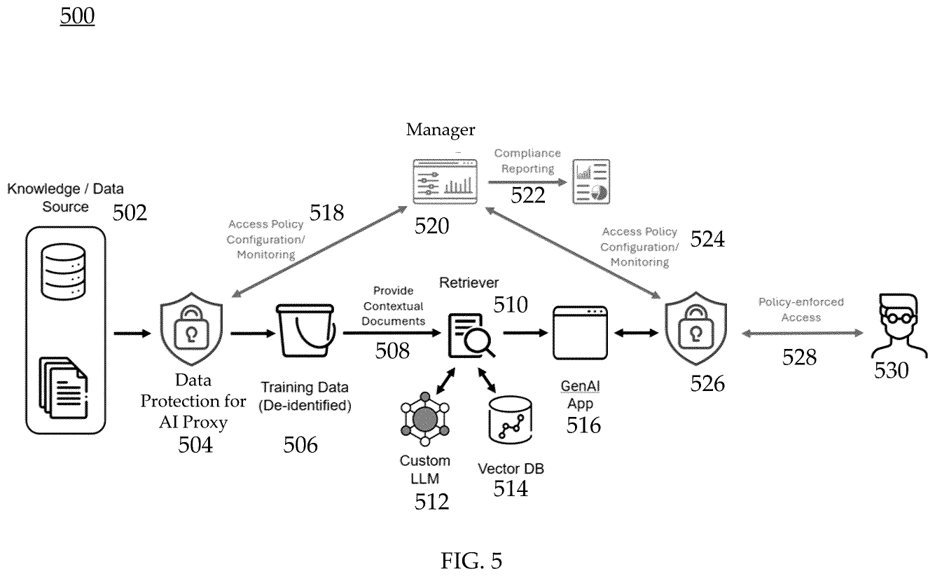

FIG. 5 is an example data protection pipeline 500 for AI used in a RAG pipeline. The manager 520 can implement proxy 504 to process input data 502 and encrypt/scrape data according to one or more access policies (e.g., access policy configuration and monitoring 518). The de-identified data can be aggregated into training data 506 that is fed into a retriever 510 with provided contextual documents 508.

Retrieval-augmented generation (RAG) is a technique for enhancing the accuracy and reliability of generative AI models with facts fetched from external sources. The RAG can include retriever 510, LLM 512, and a Vector DB 514. A vector database 514 can include a database that can store vectors (fixed-length lists of numbers) along with other data items. The vector database can implement one or more approximate nearest neighbor algorithms, so that one can search the database with a query vector to retrieve the closest matching database records. The manager 520 can implement a proxy 526 that allows a proxy-enforced access 528 to data by a user 530 interacting with a GenAI app 516. The manager 520 can also provide compliance reporting 522 and access policy configuration monitoring 518, 524 for each proxy 504, 526.

During the encryption process, the proxy can use the encryption configuration and access control policy it receives from the manager configuration service to decide how to encrypt as well as generate and store useful information in metadata attached to the encrypted value. The proxy can be in a unique position to collect this information since the proxies have access to user configuration and policies as well as the current computational and network context. The encrypted data can include but may not be limited to: universally unique identifier (UUID), Encryption key, Pre-encryption datatype, User-defined classification labels (e.g., Personally Identifiable Information (PII), payment card information (PCI), personal health information (PHI), etc.), downstream LLM type, and/or vector representation for data.

The metadata section of the encryption can use a format that allows for a variable number of metadata elements of varying length. A Tag-Length-Value (TLV) format can be used, but any encoding that allows for additional metadata values to be added to support downstream generative AI or access control usage can be used.

Among the aforementioned metadata values, the LLM type and vector representation metadata values can be of particular interest for downstream Gen-AI components. Because the proxy is present at a stage of the pipeline where it is still aware of the text corpus, it can also calculate appropriate mathematical representation of the word for the LLM used, typically position vectors. With few exceptions, this mathematical representation may not be directly stored wholly in the metadata along with the data value due to its size, so a reference pointer or locator ID can be stored in its place. In this case, the proxy can store the full mathematical representation of the word in a secure vector database it controls.

The UUID and classification can label services to create an address for the data values that access control policies can be bound to. For example, security administrators can use the manager to create a policy that requires the encryption of all credit card numbers and give access only to users with “payment processor” role. This policy can then be assigned to all the data values with the PCI classification. The net result of having a UUID and labels for the data can ensure that an access policy can be assigned to any single data values (via UUID) or arbitrary group of data values (via labels). The label can be defined arbitrarily and support any level of granularity, so if we wanted to focus only on credit card numbers in the US in our example, a label names “PCI-US” can be used and specific policies that only apply to US credit card numbers assigned to that table.

To protect the metadata stored along with the encrypted data value, a keyed cryptographic hash can be used to prevent tampering. In the case that potentially reversible or information leaking derivative values for the data are included in the metadata such as the actual vector representation of the data, such derivative values can be encrypted before being stored in the metadata. The table below shows the metadata attached to the encrypted data.

| | | | | | | | |
|---|---|---|---|---|---|---|---|
| | Key ID & | Keyed Hash | Data | LLM | ID for Vector | Keyed Hash | Encrypted |
| UUID | Hash of Key | of Data | Labels | Type | Info for Data | of Metadata | Data |

When the end user interacts with the proxy, the proxy can review the prompt and identify potentially regulated data values and encrypt those values. This can be somewhat similar to DLP solutions except that the proxy is designed to use a pluggable set of methods for identification including but limited to regular expression matching, named entity recognition, and user defined rules. The manager can provide administrators the ability to choose, configure, and, in some cases, install the sensitive data recognition mechanism. Furthermore, unlike other DLP solutions without any context, the AI models used as part of the sensitive data identification engine can incorporate the Gen-AI relevant metadata extracted as part of the encryption process as input. This data can be useful since it is very likely to be related to the context that the user is operating in. For example, a user using a generative application for reviewing insurance claims will likely input sensitive information relating to policyholders and policyholders information is likely the data set ingested into the Gen-AI application.

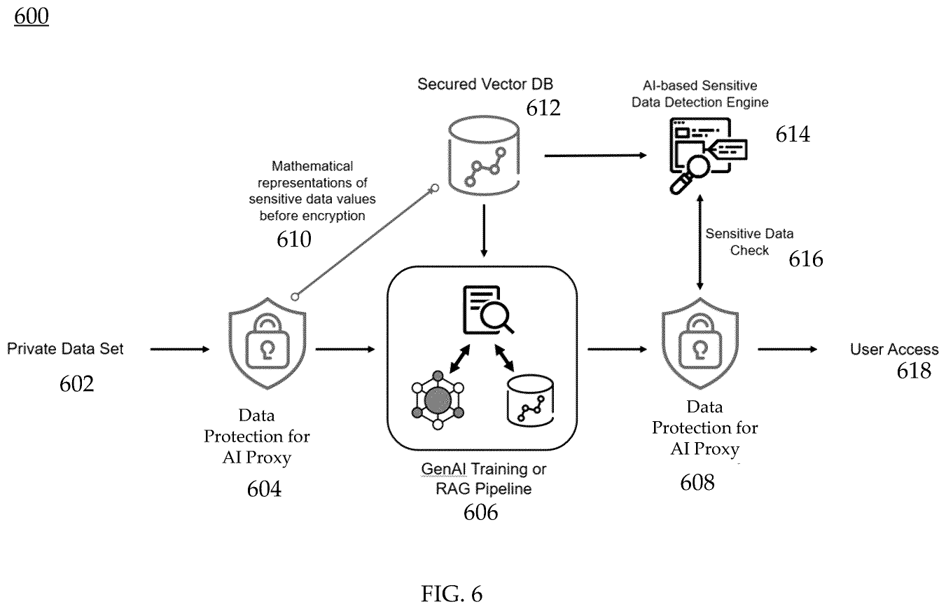

FIG. 6 illustrates a flow process 600 of an example interaction between ingestion and consumption proxies and AI components. As shown in FIG. 6, a private data set 602 can be fed to a first AI proxy 604 implemented by the manager as described herein. The proxy 604 can be associated with mathematical representations of sensitive data values before encryption 610. The mathematical representations can include position vectors that represent sensitive data values also can be stored in a secured vector database 612. The processed data from dataset 602 can be fed into a GenAI training or RAG pipeline 606, similar to processes described with respect to FIG. 4 or 5, for example.

In some instances, an AI-based sensitive data detection engine 614 can process the data set 602 and determine all data that is sensitive according to specific access control policies. For example, engine 614 can identify all data considered identifiable information (PII), payment information (PCI), health information (PHI), etc. The engine 614 can utilize one or more neural networks, LLMs, or machine learning models to detect sensitive information as described herein.

A second proxy 608 can be disposed between the GenAI app implemented by GenAI training or RAG pipeline 606 and a user 618 accessing the GenAI app via a user device. The proxy 608 can perform a sensitive data check 616 based on access control policies in place for the dataset 602 and the access for the user 618.

In addition to protecting sensitive data that may be inadvertently exposed by end user through the prompt, the proxy can use the access control policy it receives from manager and checks it against the metadata to determine whether the data should be decrypted and if the full data value should be presented or if part of the data value should be masked. For example, the metadata can be processed to determine whether only part of sensitive data should be part of the data value provided to the user or not, such as to provide only part of a social security number or payment card number of a user. Because all sensitive data values may have been encrypted and proper metadata assigned, it can be possible to assign proper access control policies on data that meet compliance requirements.

The present embodiments can use data loss prevention (DLP) technology to preserve data privacy for generative AI applications. Further, the present embodiments can be different from DLP solutions in that it identifies the sensitive data value early in the data pipeline when there's more context about the data's sensitivity. The user can also deterministically specify the sensitive data in the configuration because the data are often still in structured format. The data can be encrypted at this early stage to create a means to enforce access. With the data encrypted, even if the encrypted value is extracted from the generative AI system using some form of vulnerability or bypass, there may not be any way to access the sensitive data value. The result is that decryption through the proxy can be required to gain access to sensitive data, and the proxy can determine whether to decrypt the data and give access based on pre-defined access control policies. As a result, there may be no ambiguity as to whether or not a given user has access to a protected sensitive data value.

In the occasional case where the sensitive data comes from the end user in violation of typical corporate information security policies, the proxy can be differentiated from existing DLP solutions in that the sensitive data detection engine can make use of information about the data set that was collected by a proxy during the encryption process to improve sensitive data identification. This awareness of the sensitive data set that the application uses provides useful contexts for the sensitive data detection to greatly improve its accuracy.

The present embodiments can also use Cloud Access Security Broker (CASB) for performing encryption using an inline proxy. The present embodiments can differ from these encrypting proxies for HTTP in that it can support multiple protocols that can encrypt data values for infrastructure components such as database and file servers in addition to applications. First, the CASB solution can be focused on simple encryption and decryption of values and leaves access control at the data value level to the software as a service (SaaS) application whereas the solution stores a rich set of metadata required to enable use of the protected values by generative AI components and for access control downstream, Second, the CASB encryption proxies may not be designed to store such a rich set of metadata, especially those needed for generative AI application and they lack the facilities to generate any metadata for use by generative AI components whereas the solution is well suited for generative AI. Lastly, the encryption proxies can support encryption and decryption using different types of proxies, so it is easy to encrypt sensitive data using a proxy for one protocol and later decrypt the data value that is transmitted on another network protocol. This can be critical for use in generative AI pipelines since the protocols used in the data ingestion path are almost always different from those used in the end user consumption path.

Alternate approaches for encrypting individual data values can also be used. The present solution can differ from the software development kit (SDK) and Representational State Transfer Application Programming Interface (REST API) solutions because it can be capable of processing an entire text corpus at a time and encrypt individual values within. By being able to see the entire body of text, the proxy can calculate relevant mathematical representations of interest for downstream use by LLM components for sensitive data values and store it securely in the metadata or in a separate secured database.

The present solution introduces the use of multiple heterogeneous proxies to perform encryption and decryption and masking at different points in the data pipeline. The solution can also generate access control and AI related metadata at data ingestion. This set of metadata can enable the solution to provide access control on sensitive data required by compliance regulations. It also can enable the generative AI system to perform its operations without directly knowing the data value. Lastly, the solution can provide the ability to detect and protect sensitive data that may inadvertently be given by the user as part of the application input.

In other solutions, encryption proxies may not be used to protect data ingested into a generative AI pipeline. Further, encryption proxies for different network protocols have to been used in conjunction to protect data used in generative AI data pipeline and application such that data may be encrypted using a proxy for one protocol and decrypted using a proxy of another one. Encryption of individual data values, with or without use of an encryption proxy, may have not attempted to calculate generative AI relevant metadata in conjunction with associated access control metadata and store it with the encrypted values. Proxies that provide DLP capabilities, namely preventing security sensitive data from exposed beyond a security boundary by attempting to detect sensitive data and blocking or de-identifying the sensitive data, may not have been made use of AI-relevant mathematical representation of relevant sensitive data values to aid the sensitive data identification engine.

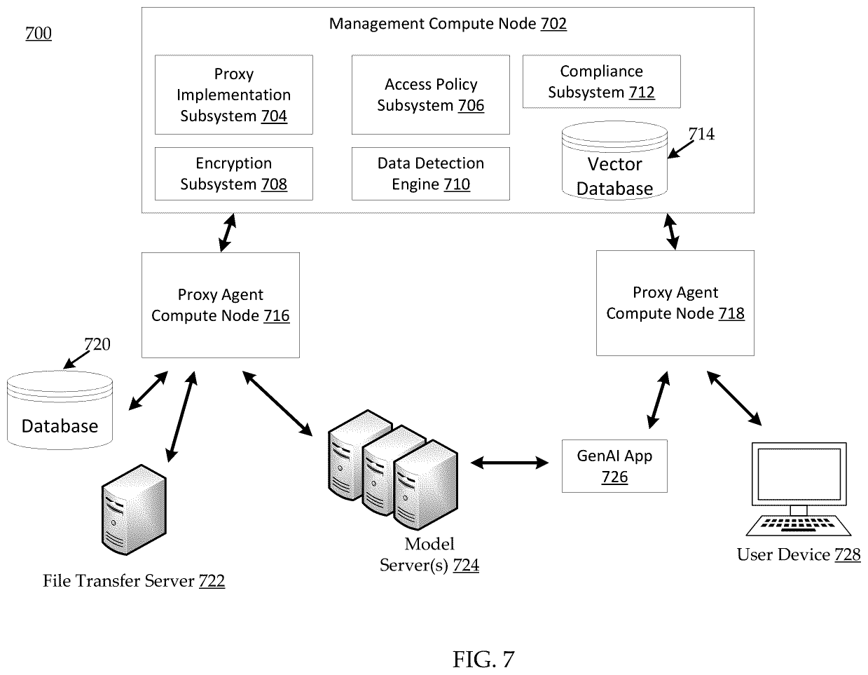

FIG. 7 is a diagram illustrating an example system 700 for selectively encrypting data for a generative artificial intelligence (GenAI) application. As shown in FIG. 7, a management compute node 702 can implement proxy agent compute nodes 716, 718. The management compute node 702 can include a computing node or series of interconnected servers that are configured to perform operations for selectively encrypting data for a GenAI application as described herein.

The management compute node 702 can include a proxy implementation subsystem 704. The proxy implementation subsystem 704 can implement and control proxy agent compute nodes 716, 718 as described herein. The proxy agent compute nodes 716, 718 can include virtual compute instances managed by the management compute node 702 or separate computing instances.

The proxy implementation subsystem 704 can implement a first proxy compute node 716 that can be electrical communication with one or more input data sources, such as database 720 and file transfer server 722. The input data sources can be configured to provide a set of input data, such as a text corpus that includes various sensitive data types (e.g., PII, payment information, health information). Any of the first proxy agent compute node 716 and the second proxy agent compute node 718 can connect to a database (e.g., database 720) that is part of the input data sources via a database native communication protocol. The first proxy agent compute node and the second proxy agent compute node can also connect to a file transfer server (e.g., file transfer server 722) that is part of the input data sources via a secure file transfer protocol (SFTP). The first proxy agent compute node and the second proxy agent compute node can connect to a cloud-based server that is part of the input data sources via hypertext transfer protocol secure (HTTPS).

The first proxy agent compute node 716 can also be electrically connected to model server(s) 724. The model servers 724 can implement models, repositories, databases, etc., relating to an AI or neural network application. For instance, model servers 724 can implement a large language model (LLM) or a retrieval-augmented generation (RAG) system as described herein. The model servers 724 can train on input data that includes all input data or a de-identified set of the input data. In some instances, the model servers 724 may train on input data that has sensitive information encrypted or marked via the UUID and the data type as described herein.

For instance, a LLM can train on insurance claim data with all PII about clients encrypted and identifiable by the UUID. In response to the user having access to the PII in this example, the LLM can interact with the manager to have data retrieved from the vector database and decrypted. The LLM can process the prompt using either the de-identified data or the decrypted data and generate a response to the prompt. In some instances, The LLM can generate a response to the prompt that includes UUIDs of encrypted data, and the second proxy can decrypt the data values using the UUIDs of the encrypted data and transmit the response to the query with the decrypted data values to the user device.

The access policy subsystem 706 can manage access control policies. A set of access control policies can dictate data types to be encrypted, metadata to be stored, and what users have access to what types of the encrypted data. For example, a set of access control policies can dictate to have all PII data (e.g., patient names), payment card information, and health record information encrypted. Further, the access control policies can specify that a medical provider can have only health record information and PII data decrypted due to their access level, but the access level may not give permission to decrypt payment card information.

The management compute node 702 can transmit a set of access control policies to the first proxy agent compute node 716 and the second proxy agent compute node 718 that is common across the proxies. The set of access control policies can include defined classification labels for each type of data values that are to be encrypted. For example, a defined classification label can include payment card information, such as a credit card number.

Further, each of the identified set of data values in the input data that include sensitive information can include any of: a universally unique identifier (UUID) for each data value, an encryption key for encrypting the data value, a pre-encryption data type for the data value, a defined classification label for the data value, a LLM type, and a vector representation of the data value.

The metadata for each data value can be arranged in a tag-length-value format that arranges multiple metadata elements of varying lengths (e.g., data type for data value, text corpus from which the data value is derived, access control policy).

In some instances, the first proxy agent compute node generates a position vector for each data value in the identified set of data values. The position vector comprises a mathematical representation of the data value. For example, a position vector can be generated for a social security number that is a mathematical representation of the data type (e.g., PII) and the actual data value (e.g., the numeric string of values comprising the social security number).

The encryption subsystem 708 can encrypt data values as described herein. For example, responsive to a data value being identified as comprising PII, such as a social security number, the encryption subsystem 708 can encrypt all or part of the social security number according to an encryption key. The encrypted data value and the metadata can be encrypted using a keyed cryptographic hash.

In some instances, the first proxy agent compute node 716 can store the position vector for each data value in the database that comprises a vector database 714. The vector database 714 can securely store vectors for each encrypted data value and associated metadata that can be retrieved for subsequent decryption or masking.

In some instances, the UUID and defined classification label for the data value can create an address for each data value for the set of access control policies. The addresses defined by the UUID and label for each encrypted data value can act as a header or identifier for encrypted data to be decrypted for users with an appropriate access level. For example, all encrypted data relating to health information can be addressed by a UUID for each piece of data and the label classifying the data as private health data. In response to determining a user (e.g., a physician) has sufficient access to such data, the data can be identified to be decrypted based on the address for the data.

A remaining portion of the input data (e.g., data not identified as sensitive information and encrypted) to the models 724 as training data to train the models 724. For example, the data forwarded to models 724 can be processed as training data to train models 724 comprising a LLM or RAG system.

The data detection engine 710 can process the input data and determine if any data values were missed in the initial detection of sensitive data. For example, the data detection engine 710 can include an AI model that can catch any health data or PII that was not initially identified as data to be encrypted. In these cases, the data detection engine 710 can encrypt or mask the identified data as described herein.

The compliance subsystem 712 can manage compliance of the set of access policies against compliance standards. For example, compliance subsystem 712 can determine whether a set of access policies are within standards for a specific rule, such as a medical-related law protecting privacy of health data. The compliance subsystem 712 can implement one or more models that are used in generation of access policies and enforcement of access policies. In some instance, the compliance subsystem 712 can generate a compliance report tracking how different data types were in compliance with various rules.

In some instances, compliance subsystem 712 can determine whether the set of access control policies are within a set of compliance parameters. For example, the set of compliance parameters include data types that are to be encrypted due to a medical-related rule and only health provider users are allowed to have such data types decrypted. The compliance subsystem 712 can add a set of access control policies and the determination of whether the set of access control policies are within the set of compliance parameters to a compliance report. The compliance report can specify the compliance parameters, the set of access control policies, and/or whether any data types were misidentified or not encrypted by the proxy agent compute node 716.

The user device 728 can provide a prompt to the proxy agent compute node 718. The prompt can include a text-based prompt to be processed by the GenAI app 726. The proxy agent compute node 718 can communicate with management compute node 702 to identify an access level for the user device according to the set of access control policies. The access level for the user device 728 can specify what data types are to be decrypted when the GenAI app 726 processes the prompt and provides a response to the prompt. For example, if the access level for the user device allows for access to payment card data, the GenAI app 726 can obtain decrypted payment card data that can be included in the response to the prompt provided back to the user device 728.

All or a portion of the encrypted data values in the response to the prompt can be decrypted based on the access level for the user device. For example, if an access level allows for part of social security numbers to be decrypted, the encryption system 708 can decrypt the last four digits of social security numbers in generation of the response to the prompt by the GenAI app 726. The response to the prompt can be sent from the GenAI app 726 to the user device.

### Example Computer Devices

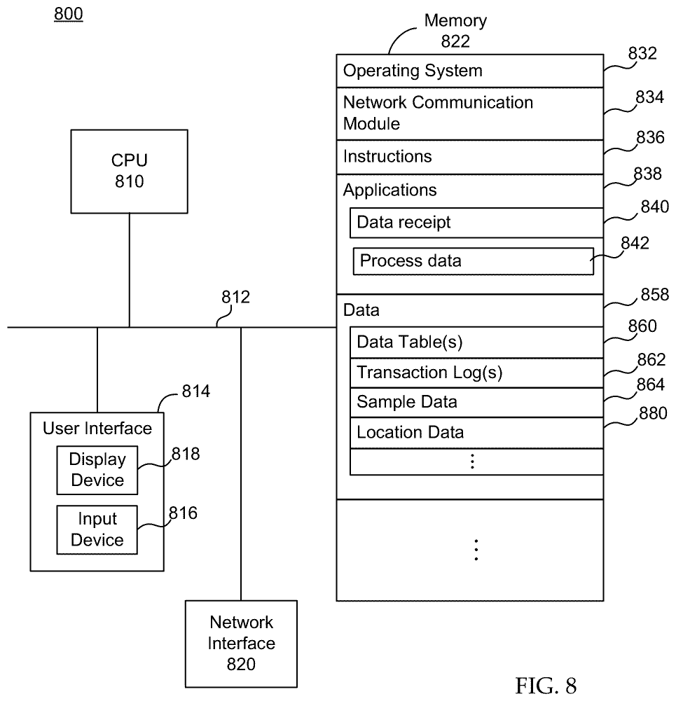

FIG. 8 shows an example computing device 800 which may be used in the systems and methods described herein. In the example computer 800 a CPU or processor 810 is in communication by a bus or other communication 812 with a user interface 814. The user interface includes an example input device 816 such as a keyboard, mouse, touchscreen, button, joystick, or other user input device(s). The user interface 814 also includes a display device 818 such as a screen. The computing device 800 shown in FIG. 8 also includes a network interface 820 which is in communication with the CPU 820 and other components. The network interface 820 may allow the computing device 800 to communicate with other computers, databases, networks, user devices, or any other computing capable devices. In some examples, additionally or alternatively, the method of communication may be through WIFI, cellular, Bluetooth Low Energy, wired communication, or any other kind of communication. In some examples, additionally or alternatively, the example computing device 800 includes peripherals also in communication with the processor 810. In some examples, additionally or alternatively, peripherals include stage motors such as electric servo and/or stepper motors used for moving the probe up and down. In some example computing devices 800, a memory 822 is in communication with the processor 810. In some examples, additionally or alternatively, this memory 822 may include instructions to execute software such as an operating system 832, network communications module 834, other instructions 836, applications 838, applications to control the spectrometer and/or light source 840, applications to process data 842, data storage 858, data such as data tables 860, transaction logs 862, sample data 864, sample location data 880 or any other kind of data.

### CONCLUSION

As disclosed herein, features consistent with the present inventions may be implemented by computer-hardware, software and/or firmware. For example, the systems and methods disclosed herein may be embodied in various forms including, for example, a data processor, such as a computer that also includes a database, digital electronic circuitry, firmware, software, computer networks, servers, or in combinations of them. Further, while some of the disclosed implementations describe specific hardware components, systems and methods consistent with the innovations herein may be implemented with any combination of hardware, software and/or firmware. Moreover, the above-noted features and other aspects and principles of the innovations herein may be implemented in various environments. Such environments and related applications may be specially constructed for performing the various routines, processes and/or operations according to the invention or they may include a general-purpose computer or computing platform selectively activated or reconfigured by code to provide the necessary functionality. The processes disclosed herein are not inherently related to any particular computer, network, architecture, environment, or other apparatus, and may be implemented by a suitable combination of hardware, software, and/or firmware. For example, various general-purpose machines may be used with programs written in accordance with teachings of the invention, or it may be more convenient to construct a specialized apparatus or system to perform the required methods and techniques.

Aspects of the method and system described herein, such as the logic, may be implemented as functionality programmed into any of a variety of circuitry, including programmable logic devices (“PLDs”), such as field programmable gate arrays (“FPGAs”), programmable array logic (“PAL”) devices, electrically programmable logic and memory devices and standard cell-based devices, as well as application specific integrated circuits. Some other possibilities for implementing aspects include: memory devices, microcontrollers with memory (such as EEPROM?), embedded microprocessors, firmware, software, etc. Furthermore, aspects may be embodied in microprocessors having software-based circuit emulation, discrete logic (sequential and combinatorial), custom devices, fuzzy (neural) logic, quantum devices, and hybrids of any of the above device types. The underlying device technologies may be provided in a variety of component types, e.g., metal-oxide semiconductor field-effect transistor (“MOSFET”) technologies like complementary metal-oxide semiconductor (“CMOS”), bipolar technologies like emitter-coupled logic (“ECL”), polymer technologies (e.g., silicon-conjugated polymer and metal-conjugated polymer-metal structures), mixed analog and digital, and so on.

It should also be noted that the various logic and/or functions disclosed herein may be enabled using any number of combinations of hardware, firmware, and/or as data and/or instructions embodied in various machine-readable or computer-readable media, in terms of their behavioral, register transfer, logic component, and/or other characteristics. Computer-readable media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof. Examples of transfers of such formatted data and/or instructions by carrier waves include, but are not limited to, transfers (uploads, downloads, e-mail, etc.) over the Internet and/or other computer networks by one or more data transfer protocols (e.g., HTTP, FTP, SMTP, and so on).

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

Although certain presently preferred implementations of the invention have been specifically described herein, it will be apparent to those skilled in the art to which the invention pertains that variations and modifications of the various implementations shown and described herein may be made without departing from the spirit and scope of the invention. Accordingly, it is intended that the invention be limited only to the extent required by the applicable rules of law.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated. Etc.

What is claimed is:

1. A method performed to selectively encrypt data for a generative artificial intelligence (GenAI) application, the method comprising:
implementing, by a management compute node, a first proxy agent compute node in electrical communication with one or more input data sources configured to provide a set of input data and a large language model (LLM) or a retrieval-augmented generation (RAG) system, wherein the management compute node transmits a set of access control policies to the first proxy agent compute node;
identifying, at the first proxy agent compute node, a set of data values in the input data that include sensitive information as defined in the set of access control policies;
for each data value in the identified set of data values:
encrypting the data value; and
storing the encrypted data value with metadata at a database;
forwarding a remaining portion of the input data to the LLM or the RAG system as training data to train the LLM or the RAG system;
implementing a second proxy agent compute node in electrical communication with a user device and a GenAI application in communication with the LLM or the RAG system;
obtaining, at the second proxy agent compute node, a prompt from the user device;
identifying an access level for the user device according to the set of access control policies;
obtaining, at the second proxy agent compute node, a response to the prompt from the GenAI application;
decrypting all or a portion of the encrypted data values in the response to the prompt based on the access level for the user device; and
transmitting, by the second proxy agent compute node, the response to the prompt to the user device with the decrypted data values.

2. The method of claim 1, wherein any of the first proxy agent compute node and the second proxy agent compute node connects to a database that is part of the input data sources via a database native communication protocol, the first proxy agent compute node and the second proxy agent compute node connects to a file transfer server that is part of the input data sources via a secure file transfer protocol (SFTP), and wherein the first proxy agent compute node and the second proxy agent compute node connects to a cloud-based server that is part of the input data sources via hypertext transfer protocol secure (HTTPS).

3. The method of claim 1, wherein the set of access control policies include defined classification labels for each type of data values that are to be encrypted.

4. The method of claim 3, wherein each of the identified set of data values in the input data that include sensitive information include any of: a universally unique identifier (UUID) for each data value, an encryption key for encrypting the data value, a pre-encryption data type for the data value, a defined classification label for the data value, a LLM type, and a vector representation of the data value.

5. The method of claim 1, wherein the metadata for each data value is arranged in a tag-length-value format that arranges multiple metadata elements of varying lengths.

6. The method of claim 1, wherein the input data received at the first proxy agent compute node comprises a full text corpus, and wherein the first proxy agent compute node generates a position vector for each data value in the identified set of data values, wherein the position vector comprises a mathematical representation of the data value.

7. The method of claim 6, wherein the first proxy agent compute node stores the position vector for each data value in the database that comprises a vector database.

8. The method of claim 4, wherein the UUID and defined classification label for the data value create an address for each data value for the set of access control policies, wherein the second proxy agent compute node is configured use the address for each data value to provide a decrypted data value in the response to the prompt.

9. The method of claim 1, wherein the encrypted data value and the metadata are encrypted using a keyed cryptographic hash.

10. The method of claim 1, further comprising:
detecting, by a detection engine in communication with the second proxy agent compute node, a first data value that was misidentified by the first proxy agent compute node; and
encrypting or masking the first data value according to the set of access control policies.

11. A management compute node comprising:
one or more processors; and
a memory with instructions that, when executed, cause the one or more processors to:
implement a first proxy agent compute node in electrical communication with one or more input data sources configured to provide a set of input data and a large language model (LLM) or a retrieval-augmented generation (RAG) system;
transmit a set of access control policies to the first proxy agent compute node, wherein the first proxy agent compute node is configured to:
identify a set of data values in the input data that include sensitive information as defined in the set of access control policies;
for each data value in the identified set of data values:
encrypt the data value; and
store the encrypted data value with metadata at a database;
forward a remaining portion of the input data to the LLM or the RAG system as training data to train the LLM or the RAG system;
implement a second proxy agent compute node in electrical communication with a user device and a GenAI application in communication with the LLM or the RAG system; and
transmit the set of access control policies to the second proxy agent compute node, wherein the second proxy agent compute node is configured to:
obtain a prompt from the user device;
identify an access level for the user device according to the set of access control policies;
obtain a response to the prompt from the GenAI application;
decrypt all or a portion of the encrypted data values in the response to the prompt based on the access level for the user device; and
transmit the response to the prompt to the user device with the decrypted data values.

12. The management compute node of claim 11, wherein any of the first proxy agent compute node and the second proxy agent compute node connects to a database that is part of the input data sources via a database native communication protocol, the first proxy agent compute node and the second proxy agent compute node connects to a file transfer server that is part of the input data sources via a secure file transfer protocol (SFTP), and wherein the first proxy agent compute node and the second proxy agent compute node connects to a cloud-based server that is part of the input data sources via hypertext transfer protocol secure (HTTPS).

13. The management compute node of claim 12, wherein each of the identified set of data values in the input data that include sensitive information include any of: a universally unique identifier (UUID) for each data value, an encryption key for encrypting the data value, a pre-encryption data type for the data value, a defined classification label for the data value, a LLM type, and a vector representation of the data value.

14. The management compute node of claim 11, wherein the input data received at the first proxy agent compute node comprises a full text corpus, and wherein the first proxy agent compute node generates a position vector for each data value in the identified set of data values, wherein the position vector comprises a mathematical representation of the data value, wherein the first proxy agent compute node stores the position vector for each data value in the database that comprises a vector database.

15. The management compute node of claim 11, wherein the instructions further cause the one or more processors to:
detect a first data value mis-identified by the first proxy agent compute node; and
encrypt or mask the first data value according to the set of access control policies.

16. A computer-implemented method comprising:
implementing a first proxy agent compute node in electrical communication with one or more input data sources configured to provide a set of input data and a model for a generative artificial intelligence (GenAI) application;
transmitting a set of access control policies to the first proxy agent compute node, wherein the first proxy agent compute node is configured to:
identify a set of data values in the input data that include sensitive information as defined in the set of access control policies;
for each data value in the identified set of data values:
encrypt the data value; and
store the encrypted data value with metadata at a database;
implementing a second proxy agent compute node in electrical communication with a user device and the GenAI application in communication with the model; and
transmitting the set of access control policies to the second proxy agent compute node, wherein the second proxy agent compute node is configured to:
obtain a prompt from the user device;
identify an access level for the user device according to the set of access control policies;
obtain a response to the prompt from the GenAI application;
decrypt all or a portion of the encrypted data values in the response to the prompt based on the access level for the user device; and
transmit the response to the prompt to the user device with the decrypted data values.

17. The computer-implemented method of claim 16, wherein any of the first proxy agent compute node and the second proxy agent compute node connects to a database that is part of the input data sources via a database native communication protocol, the first proxy agent compute node and the second proxy agent compute node connects to a file transfer server that is part of the input data sources via a secure file transfer protocol (SFTP), and wherein the first proxy agent compute node and the second proxy agent compute node connects to a cloud-based server that is part of the input data sources via hypertext transfer protocol secure (HTTPS).

18. The computer-implemented method of claim 16 wherein each of the identified set of data values in the input data that include sensitive information include any of: a universally unique identifier (UUID) for each data value, an encryption key for encrypting the data value, a pre-encryption data type for the data value, a defined classification label for the data value, a LLM type, and a vector representation of the data value.

19. The computer-implemented method of claim 16, wherein the input data received at the first proxy agent compute node comprises a full text corpus, and wherein the first proxy agent compute node generates a position vector for each data value in the identified set of data values, wherein the position vector comprises a mathematical representation of the data value, wherein the first proxy agent compute node stores the position vector for each data value in the database that comprises a vector database.

20. The computer-implemented method of claim 16, further comprising:
determining whether the set of access control policies are within a set of compliance parameters; and
adding the set of access control policies and the determination of whether the set of access control policies are within the set of compliance parameters to a compliance report.
